(19) United States
(12) Patent Application Publication
(10) Pub. No.: US 2011/0110213 A1
(43) Pub. Date: May 12, 2011

(54) OPTICAL COMPONENT LASER-WELDED STRUCTURE AND OPTICAL PICKUP MANUFACTURING METHOD

(75) Inventors: Satoshi ARAI, Yokohama (JP); Hiroaki Furuichi, Kawasaki (JP); Mitsuo Satake, Yokohama (JP)

(73) Assignee: Hitachi Media Electronics Co. Ltd.

(21) Appl. No.: 12/898,744

(22) Filed: Oct. 6, 2010

(30) Foreign Application Priority Data
Nov. 11, 2009 (JP) 2009-257699

(51) Int. Cl. G11B 7/00; B32B 37/04

(52) U.S. Cl. 369/100; 156/272.8; 156/272.6; G9B/7

(57) ABSTRACT

In a laser welding method, detachment is suppressed and dislocation of an optical component is reduced by improving adhesiveness of an interface of a welded part to thereby improve yield and reliability of an optical pickup device. A manufacturing method of an optical pickup device includes: a step of bringing the optical component into contact with the holding member; a step of irradiating laser light; and a step of melting the holding member through the irradiation to weld the holding member to the optical component, wherein before the laser light is irradiated, surface roughness of a portion of the optical component to be welded is greater than surface roughness of the holding member in contact with the portion, whereby the melted holding member enters into an uneven part on a front surface of the optical component, improving adhesion strength.

### BACKGROUND OF THE INVENTION

1. Field of the Invention

The present invention relates to an optical pickup device that performs recording and reproduction on and from an optical disc in an optical disc drive device, and also relates to an optical component fixing technology.

2. Description of the Related Arts

An optical pickup device for use in recording and reproduction on and from an optical disc of such as a CD, a DVD, or a Blu-ray disc (each is a registered trademark) is configured to guide light exiting from a light-emitting element such as a laser diode via various lenses, a prism, a mirror, etc. to an objective lens, condense it on the optical disc, then receives light returning from the optical disc, with the photodiode via the objective lens, the various lenses, the mirror and the like, and then convert it into a photoelectrical signal.

In this configuration, optical components such as the various lenses are arranged and then fixed at predetermined position on an optical path of a pickup case, and high fixation accuracy (approximately submicrons) is required for the optical components. A most frequently used fixing method is a method of positioning the optical components with a jig, applying an ultraviolet-curing adhesive to the predetermined position, and irradiating ultraviolet rays. However, the fixing with the ultraviolet-curing adhesive does not result in an ideal shape due to variations in location and amount of the applied adhesive, thus causing a problem that long-term dislocation of the optical components is likely to occur and thus reliability of the optical pickup device is likely to deteriorate. Moreover, to stabilize and completely cure the adhesive, annealing time and a duration during which the ultraviolet rays are irradiated need to be elongated, which also raises a productivity-related problem.

Suggested as a substitute technology in place of the method of fixing with an adhesive is a method of fixing by welding the optical components to a case with laser light in order to improve position stability and productivity of the optical components. This laser welding technology is used not only for fixing the optical components but also for fixing various components in the industry. Typically used in the laser welding, in order to ensure a welding area, is a method of welding on line or on circle while scanning with a laser light source or a fixing jig. Usually, a lens material most frequently used for the optical pickup is cycloorefin-based resin as non-crystalline resin, and frequently used resin for the optical pickup case is PPS (polyphenylene sulfide) as crystalline resin. Performing the laser welding with composition of these types of resin results in low compatibility due to a large solubility parameter difference therebetween, which raises a problem in ensuring adhesiveness. Moreover, the PPS resin tends to have a small linear expansion coefficient since a glass filler is added thereto in order to improve rigidity. Thus, at time of the laser welding, that is, rapidly cooling down the resin from a heated state, stress in accordance with the very large linear expansion coefficient difference is generated in the lens material and the optical pickup case material. As a result, detachment frequently occurs at part of an interface at the time of rapid cooling. Further, occurrence and advancement of the detachment from the interface of the welded part have also been identified upon introduction to the reliability test, for example, a thermal shock test most susceptible to the thermal stress.

Therefore, in order to improve the positional stability of the optical components and make best use of the advantage of the laser welding in, for example, short-tact production, it is necessary to ensure the welding strength, that is, adhesiveness of the interface.

Japanese Patent Application Laid-Open Publication No. 2005-67208 describes that an engaged convex is provided on a non-transmissive resin side and an engaged concave is provided on a transmissive resin side and then in this state laser welding of an entire outer surface of the engaged convex and an entire inner surface of the engaged concave is performed, whereby more laser light arrive and is absorbed at a joint surface, improving joint strength.

Japanese Patent Application Laid-Open Publication No. 2005-339989 describes a method of, upon joining a lens and a housing through laser welding forming a minutely uneven part at a welded portion so that the lens and the housing reliably make contact with each other at time of the laser welding to thereby achieve joining while a reliable contact state is maintained.

Japanese Patent Application Laid-Open Publication No. 2008-232885 describes a method of joining microchips by, where surface roughness of surfaces, other than an inner surface, of a flow path groove of a chip substrate is equal to or larger than a film thickness of an SiO₂ film formed on a front surface, superimposing the chips under the condition that the surface where the flow path groove is formed is located inside and then applying ultrasonic waves.

Japanese Patent Application Laid-Open Publication No. 2008-302700 discloses that providing and pressurizing projected line formed of a triangle, a rectangle, and a trapezoid on a side where absorbent resin and transmissive resin make contact with each other can improve an initial area, reduce a gap, and provide a firm joint surface without any defect such as a void caused by air entrainment.

Japanese Patent Application Laid-Open Publication No. 2009-116966 describes bonding an optical component to a pickup case through laser welding in an optical pickup.

The technologies disclosed in Patent Application Laid-Open Publication Nos. 2005-67208 and 2008-302700 described above, in view of dimensional tolerance of a molded product, is impossible for those other than components that can be fully pressurized, and applying these technologies to an optical component such as a lens results in a problem that aberration caused by distortion occurs. Moreover, with the technology of Patent Application Laid-Open Publication No. 2008-302700 in particular, shift occurs at time of the pressurization due to an influence of the dimensional tolerance of the molded product, which makes it difficult to form a welded part with high accuracy.

The technology disclosed in Patent Application Laid-Open Publication No. 2005-339989 described above is a method of improving adhesiveness by flattening the minutely uneven part with a relatively large height of 10 to 500 μm, and is effective only when the pressurization can be satisfactorily performed. Thus, this method is also not applicable to optical components, such as an optical pickup, that is compact and has strict aberration properties.

With the technology disclosed in Patent Application Laid-Open Publication No. 2008-232885, a roughness of Ra 5 to 25 μm of the minutely uneven part is relatively large and ultrasonic waves are used for welding, and thus this technology is not applicable to optical components in terms of distortion.

### SUMMARY OF THE INVENTION

It is an object of the present invention to provide an optical pickup device and an optical component laser-welded structure with high yield and high reliability by forming a minutely uneven part at least part of a laser-welded surface of non-crystalline resin as a material of the optical component, providing it with larger roughness than that of crystalline resin as a pickup case material, and then performing laser welding in a slightly pressurized state to suppress detachment of a welded part and drastically reduce dislocation of the optical component due to an environmental change.

A manufacturing method of an optical pickup device with an optical component welded to a holding member according to one aspect of the invention includes: a step of bringing the optical component into contact with the holding member; a step of irradiating laser light through the optical component to a region of the holding member in contact with the optical component; and a step of melting the holding member through the irradiation to weld the holding member to the optical component, wherein before the laser light is irradiated, surface roughness of a portion of the optical component to be welded is greater than surface roughness of the holding member in contact with the portion

In an optical pickup device with an optical component welded to a holding member according to another aspect of the invention, a welded portion between an optical component and a holding member has greater roughness at a surrounding portion thereof than at a central portion thereof.

With the present invention, in a laser welding method, detachment is suppressed and dislocation of an optical component is reduced by improving adhesiveness of an interface of a welded part to thereby improve yield and reliability of an optical pickup device.

### BRIEF DESCRIPTION OF THE INVENTION

The present invention will become fully understood from the detailed description given hereinafter and the accompanying drawings, wherein:

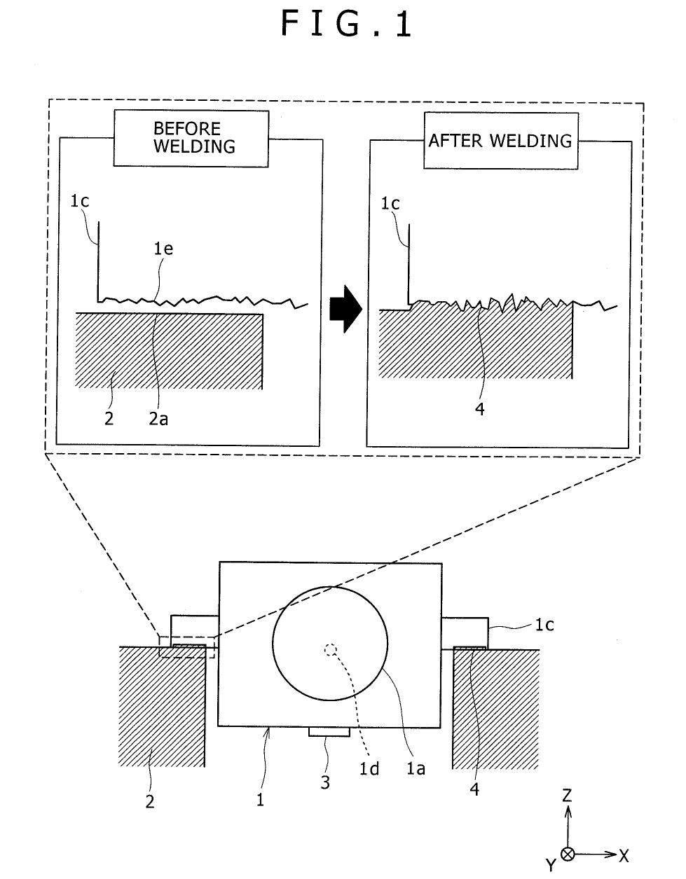

FIG. 1 is a plan view showing one embodiment of welding fixation of an optical component and a pickup case in an optical pickup device according to one embodiment of the present invention;

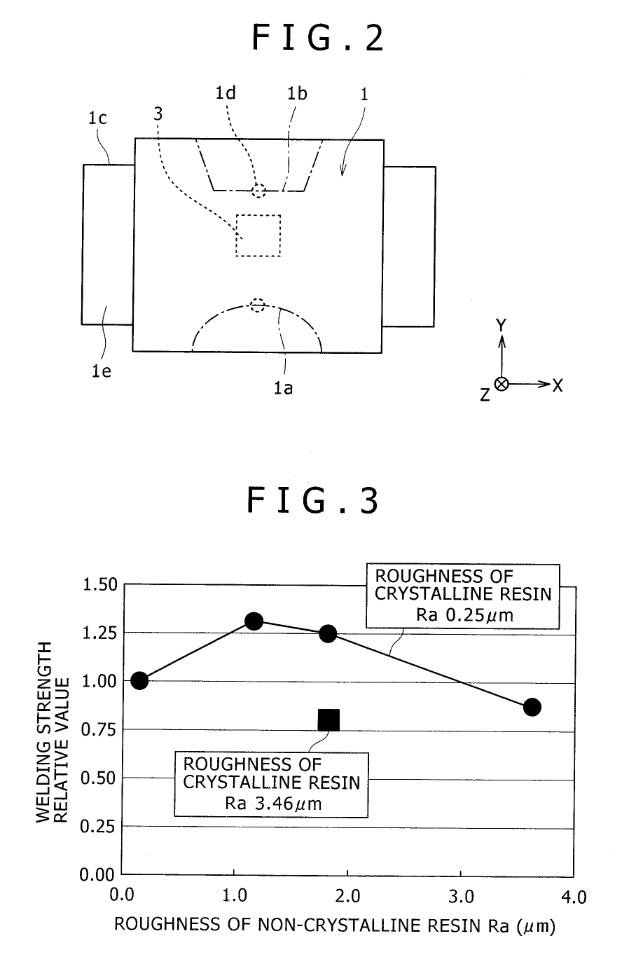

FIG. 2 is a plan view of the optical component of FIG. 1, viewed from a Z-direction (height direction of a pickup);

FIG. 3 is a welding strength comparison diagram where roughness of a flat part of a projected part of the optical component formed of non-crystalline resin is a parameter according to one embodiment of the present invention;

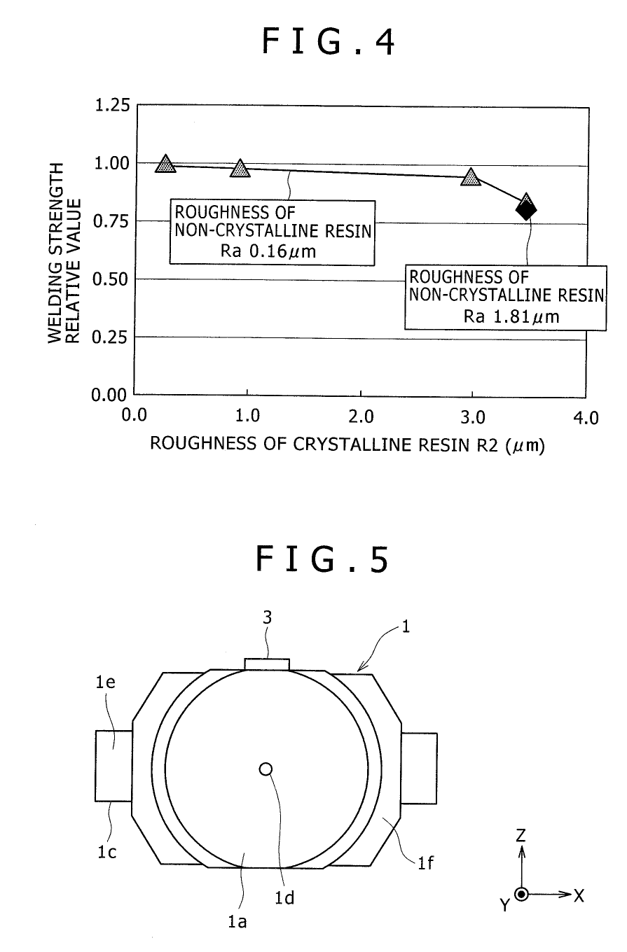

FIG. 4 is a welding strength comparison diagram where roughness of a welded surface of the pickup case formed of crystalline resin is a parameter according to one embodiment of the present invention;

FIG. 5 is a plan view showing a shape of the optical component in the optical pickup device according to another embodiment of the present invention;

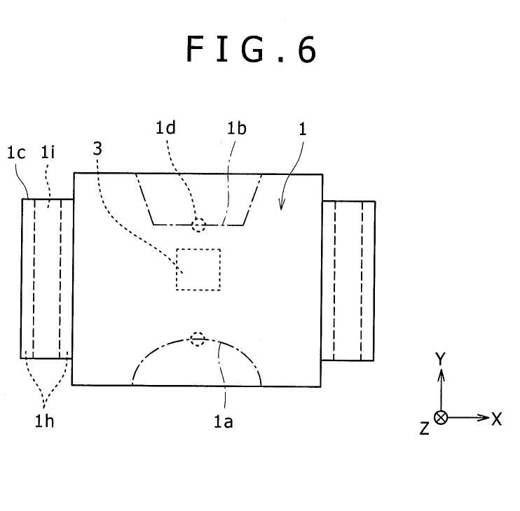

FIG. 6 is a plan view showing a welded surface of the optical component viewed from a Z-direction according to another embodiment of the present invention;

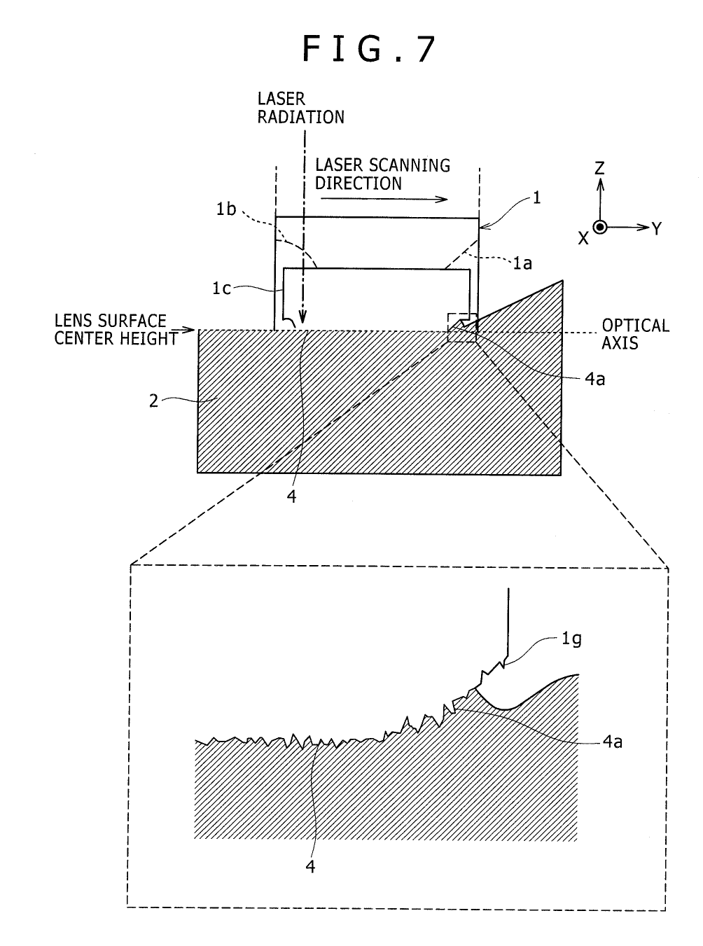

FIG. 7 is a plan view showing welding fixation of the optical component and the pickup case in the optical pickup device according to another embodiment of the present invention;

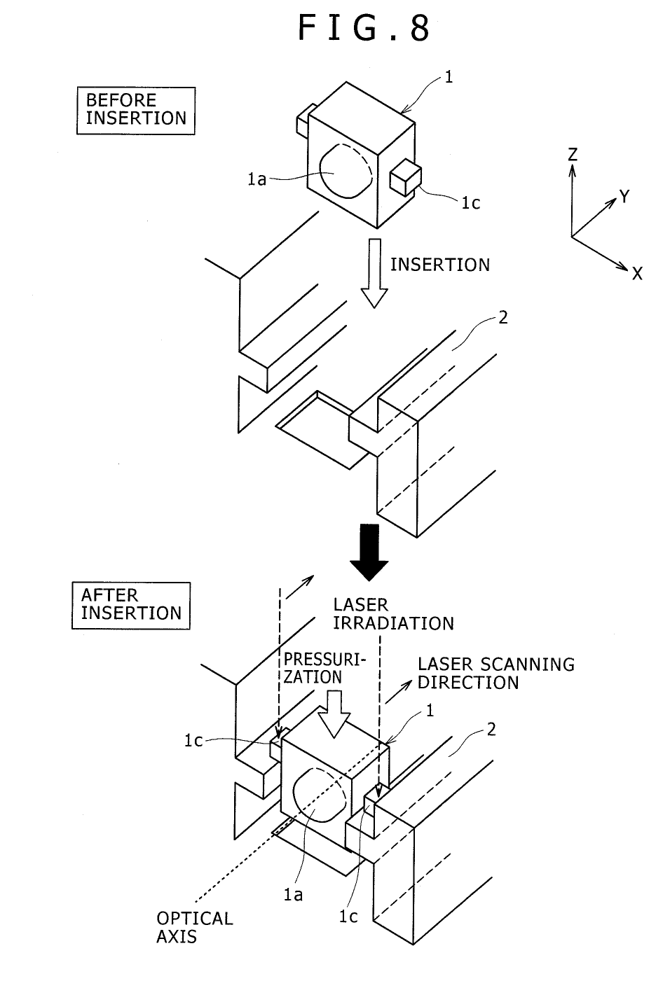

FIG. 8 is a diagram showing assembly of the optical component and the pickup case in the optical pickup device according to one embodiment of the present invention;

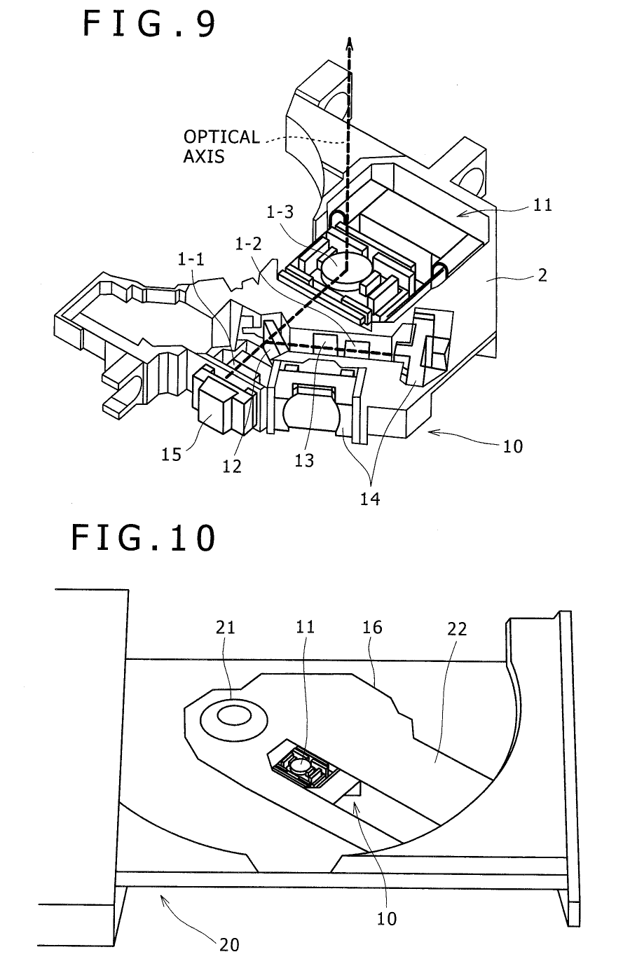

FIG. 9 is an external view showing one example of the optical pickup device according to one embodiment of the present invention; and

FIG. 10 is a diagram showing one example of an optical disc drive device assembled with the optical pickup device according to one embodiment of the present invention.

### DETAILED DESCRIPTION OF THE PREFERRED EMBODIMENTS

Hereinafter, embodiments of the present invention will be described with reference to the accompanying drawings. FIG. 9 is an external view showing one example of an optical pickup device 10 according to the present invention. Here, a detection lens 1-1, an auxiliary lens 1-2, and an objective lens 1-3 form an optical component 1 to be fixed, and are fixed to a pickup case 2 through laser welding. Numeral 11 is an actuator part, numeral 12 is a half mirror, numeral 13 is a prism, numeral 14 is a laser diode, and numeral 15 is a photodiode.

FIG. 10 is a diagram showing one example of an optical disc drive device 20 incorporating the optical pickup device 10. Numeral 17 is a metal cover, numeral 21 is a spindle motor, and numeral 22 is a drive cover.

FIG. 8 is a diagram showing assembly of the optical component 1 and the pickup case 2 in the optical pickup device 10, showing states before and after the optical component 1 is inserted into a storage part. At this point, in the laser welding, pressurizing needs to be done to ensure adhesion, but addition of great pressurizing force to the optical component results in an aberration problem of the optical component. Thus, the pressurizing force needs to be 0.3 MPa or below.

Before the insertion, the optical component 1 has, for example, a lens surface 1a in a Y-direction (an optical axis direction), and a projected part 1c in an X-direction for welding to the pickup case 2.

The optical component 1 has as targets of the laser welding, in addition to those described above, for example, a grating lens and a coupling lens. In order to have priority over transparency and aberration properties, these lenses are formed of non-crystalline resin from cycloolefin-based resin, PMMA (methyl methacrylate), fluorene-based polyester, polycarbonate, or the like as a material. On the other hand, the pickup case 2 is formed of laser-light-absorbing, black or gray crystalline resin, such as PPS (polyphenylene sulfide), PBT (polybutylene terephthalate), or liquid crystal polymer, that has a high meting point and high heat resistance.

The optical component 1 formed of the non-crystalline resin is manufactured by molding, and thus a gate part 3 remains inevitably. Thus, in a case where the gate part 3 does not become an obstacle in a height direction, it is better to provide it on a bottom side (in a Z-direction) of the optical pickup device 10. On the other hand, in a case where height limitation is strict, as is the case with the projected part 1c, it is better to provide the gate part 3 on a side-surface side (in the X-direction) of the optical component 1 at a position that avoids the projected part 1c.

After the insertion, for fixation of the optical component 1 and the pickup case 2, laser light is irradiated from above (from the Z-direction) to the projected part 1c of the optical component 1 in a pressurized state to thereby achieve the fixation through welding. For condition of the laser welding, a laser spot size, power, irradiation time and the pressurizing force are determined, taking into consideration transmittance, absorptance, heat conductivity, and compatibility of the welded materials in a laser irradiation wavelength. In terms of the transmittance of the resin, a light source used for the laser welding is preferably a laser in an infrared range including a semiconductor laser and a YAG laser. Intensity distribution of the laser light source can be any of various types of intensity distribution, such as a Gaussian type, a top hat type, or a ring type, depending on the attached lenses. In a point that a welded state can easily be uniformized, it is preferable to use a light source with the top-hat-type intensity distribution or the ring-type intensity distribution whose intensity at a central part reaches a maximum value of 50% or above.

### First Embodiment

FIG. 1 is a plan view showing one embodiment of laser welding fixation of the optical component 1 and the pickup case 2 in the optical pickup device 10 of the invention. The optical component 1 shown here has lens surfaces 1a and 1b in the optical axis direction (the Y-axis direction), has the projected part 1c provided at both ends in the X-direction in a manner such as to face a pickup case surface, and on a surface of the projected part 1c adhering to the pickup case 2, a minutely uneven part 1e is formed. Numeral 1d is a lens center position through which an optical axis passes. FIG. 2 is a plan view of the optical component 1 from the Z-direction.

To laser-weld the optical component 1 to the pickup case 2, the optical component 1 is chucked or absorbed by a jig and laser light is irradiated through the projected part 1c while scanning the laser light from the Z-direction in a state (pressurized state) in which a flat surface of the projected part 1c is pressed against a flat surface of the pickup case 2.

However, in the aforementioned combination of the optical component 1 formed of the non-crystalline resin and the pickup case 2 formed of the crystalline resin, compatibility therebetween is low, and also stress occurs in accordance with a remarkably large difference in linear expansion coefficient at time of the laser welding, that is, at time of rapidly cooling the resin from its heated state, thus frequently causing detachment at part of an interface. Further, also upon introduction to a reliability test, for example, a thermal shock test in which greatest heat stress is added, occurrence and advancement of the detachment from the interface of a welded part 4 has been identified.

In the laser welding, ensuring adhesiveness is greatly related to its welding strength and reliability. Thus, a potion where the two adhere to each other is usually finished into a mirror surface in many cases. Typically, in terms of molding, molding with crystalline resin can be achieved with better dimensional accuracy than molding with non-crystalline resin, and the non-crystalline resin is less rough than the crystalline resin in a case of finishing into the mirror surface.

This embodiment is characterized in that, at a flat part of the projected part 1c of the optical component 1 of the non-crystalline resin, the minutely uneven part 1e is formed whose roughness is greater than that of a welded surface 2a of the pickup case 2 of the crystalline resin. As a method of increasing the roughness of the minutely uneven part 1e at the flat part of such an optical component 1, crimping, blasting, or the like at the time of molding may be used. Moreover, the roughness of the minutely uneven part 1e formed at the optical component 1 needs to be equal to or larger than the wavelength of the incident laser. Providing the same level as the wavelength causes sudden light absorption at the interface, resulting in configuration not suitable for the laser welding.

Forming the minutely uneven part 1e at the flat part of the projected part 1c of the optical component 1 shown above and then performing the laser welding causes the pickup case 2 formed of the crystalline resin to melt, soften, and then thermally expand at time of the laser irradiation, and then adhere to the interface of the minutely uneven part 1e of the projected part 1c of the optical component 1. As a result, compared to conventional welding, influence of anchor effect is added, improving interface strength. FIG. 3 shows a comparative result of welding strength where a parameter is the roughness of the minutely uneven part 1e formed at the entire flat part of the projected part 1c of the optical component 1. FIG. 3 shows relative values in relation to when the roughness of the flat part of the projected part 1c of the optical component 1 is finished into a mirror surface (Ra 0.16 μm) and when the roughness of the welded surface 2a of the pickup case 2 is finished into a mirror surface (Ra 0.25 μm), where non-crystalline cycloorefin resin is used as a material of the optical component 1 and crystalline resin PPS is used as a material of the pickup case 2. Where the surface roughness Ra of the optical component 1 of the non-crystalline resin is approximately 1.0 to 2.0 μm, the welding strength relative value exceeds 1, proving that joint strength improves compared to the case where the optical component 1 is finished into the mirror surface. Where the surface roughness Ra is 3.6, the joint strength declines compared to the case where the optical component 1 is finished into the mirror surface. As described above, it has been found that setting the surface roughness Ra of the flat part of the projected part 1c of the optical component 1 greater than that in the case where the optical component 1 is finished into the mirror surface and also setting it at 3 μm or below improves the strength compared to a case where laser welding of the two finished into mirror surfaces is performed. Moreover, it has been found that in a case where the roughness Ra of the non-crystalline cycloorefin resin is 1.81 μm and the roughness Ra of the crystalline resin PPS is 3.46, the strength declines compared to the case where the two are finished into the mirror surfaces.

On the other hand, FIG. 4 shows a comparative result of welding strength where a parameter is the roughness of the welded surface 2a of the crystalline resin PPS used as the material of the pickup case 2. FIG. 4 also refers to the two finished into mirror surfaces (welding strength relative value: 1). It is proved that with an increase in the roughness of the welded surface 2a of the pickup case 2, the welding strength declines. As described above, it is proved that increasing the roughness Ra of the crystalline resin PPS does not cause strength improvement. This is because especially a welded end portion corresponding to a portion with small intensity of the incident laser adheres only through the softening and the thermal expansion in many cases, thus causing no complete adhesion when this portion is rough.

Therefore, it has been found that providing the minutely uneven part 1e on the non-crystalline resin side and finishing the crystalline-resin side into a mirror surface is the most effective means for improving the adhesiveness by increasing the roughness.

Moreover, considering that the crystalline resin gets wet with the non-crystalline resin at time of the melting, the softening, and the thermal expansion in the laser welding, it is necessary that surface free energy of the non-crystalline resin be equal to or larger than surface free energy of the crystalline resin. Especially the cycloolefin-based resin is frequently used as the material of the optical component 1, and since it has structurally no polar group, the surface free energy is very small and the crystalline resin hardly gets wet. Thus, it is preferable that the laser welding be performed after not only forming the minutely uneven part 1e at the projected part 1c of the optical component 1 but also performing any of surface-improving processing: UV ozone treatment, plasma treatment, and corona treatment to thereby improve the surface free energy of the welded surface of the optical component 1.

### Second Embodiment

FIG. 5 is a plan view showing another embodiment of the optical component 1 in the optical pickup device 10 of the invention. This is also applicable to a case where the optical component 1 is welded on a surface of the projected part 1c parallel to an optical axis 1d. Moreover, in a case where the projected part 1c for the laser welding cannot be provided in relation to a mounting area of the optical component 1, a portion 1f where parallelism of portions other than lens surfaces may be used.

### Third Embodiment

FIG. 6 is a plan view of an optical component 1 obtained by forming the minutely uneven part 1e at a portion 1h corresponding to an end portion of the welded part in the projected part 1c of the optical component 1 of this embodiment, in which roughness of the minutely uneven part 1e is larger than that of a central part 1i of the welded part. In the laser welding, there are various types of strength distribution of the incident laser, including a Gaussian type, a flat type, a ring type, etc., and even an end portion with small laser intensity may be welded in accordance with power and heat conductivity of the resin. Especially in the laser intensity distribution, for the welded part 4 corresponding to a portion with large intensity, the crystalline resin forming the pickup case 2 melts and flows to adhere to the non-crystalline resin as the optical component 1; therefore, even in a case where the two (the optical component 1 and the pickup case 2) are mirror surfaces at the time of molding before the welding, an uneven part is formed in many cases at the welded part 4 as the portion with large laser intensity after the welding. On the other hand, the end portion with small laser intensity adheres in a softened state to the non-crystalline resin. Thus, forming the minutely uneven part 1e in the vicinity of the end of the welded part 4, increasing its roughness, and providing smaller surface roughness at a section near the center of the welded part 4 than that of a section near the end of the welded part 4 through, for example, mirror surface finishing is effective means for strength improvement.

### Fourth Embodiment

FIG. 7 is a structural diagram showing another embodiment of laser-welding fixation of the optical component 1 and the pickup case 2 in the optical pickup device 10. In the laser welding, upon laser scanning on line, a terminal end portion subjected to the laser irradiation is likely to be excessively welded, causing a hole in many cases. Moreover, it has been identified in a reliability test that even in a case where proper welding is seemingly done after the welding, excessive residual stress is generated at the end portion, causing detachment from the end portion. Thus, as shown in FIG. 7, at a terminal end portion of the welded part 4 of the optical component 1 in the laser scanning direction, an inclined part 1g is provided, a welding filet 4a is formed, and in addition, a minutely uneven part is formed also at the inclined part 1g corresponding to the welding filet 4a, thereby making it possible to achieve both strength improvement and stress relaxation. Providing inclination around the welded part 4 of the pickup case 2 at this point is also effective means for the formation of the welding filet 4a, although it also depends on molding accuracy. This welding filet part 4a is formed by combined factors of rapid thermal expansion due to the laser irradiation to the pickup case 2 formed of the crystalline resin and outgas. The minutely uneven part adheres to the welding filet 4a in a softened state, and thus it is preferable that surface roughness of the minutely uneven part be larger than that of the welded surface of the pickup case 2. Moreover, when the optical component 1 and the pickup case 2 are brought to adhere to each other before the welding, the inclined part 1g is located at a position not adhering thereto, and therefore enlarging the uneven part does not worsen the adhesiveness. Thus, the surface roughness of the uneven part of the inclined part may be larger than that of an uneven part of any other welded portion of the optical component 1.

In this embodiment, the pickup case has the inclined part, but may alternatively have a groove or a notch other than the inclined part as long as it is shallowly hollowed by being more recessed than the laser-welded surface. It is preferable that a distance between the inclined part 1g of the projected part 1c of the optical component 1 and the pickup case 2 be 50 μm or below. Moreover, in FIG. 7, a portion where the welding filet 4a is formed is located only at the terminal end in the laser scanning direction (longitudinal direction of the laser welded portion), but it is not necessarily limited to the terminal end in the laser scanning direction.

The embodiments above have been described, referring to the optical pickup device 10 as an example. This structure is effective for not only the optical component 1 of the optical pickup device 10 but also a product using an optical component such as a cellular phone or a digital camera and general laser-welded structures using a laser-transmissive component other than the optical component.

In recent years, following downsizing and thinning of an optical pickup device, there have been demands for higher-speed recording onto optical disc media with various standards. To meet these standards with one optical pickup device, a design margin is decreased and also even higher accuracy is required for fixing the optical component. Use of each of the embodiments described above more dramatically reduces dislocation of the optical component than a conventional fixing method with only an adhesive, making it possible to also dramatically improve productivity. Moreover, the improvement in the welding strength can suppress the detachment at time of welding or a reliability test, making it possible to fully make better use of advantages of the laser welding. Therefore, the invention greatly contributes to achieving higher reliability and lower costs of the optical pickup device and the optical disc drive device.

What is claimed is:

1. A manufacturing method of an optical pickup device having:
a pickup case;
an optical element; and
an optical component welded to a holding member,
the manufacturing method comprising the step of:
bringing the optical component into contact with the holding member;
irradiating laser light through the optical component to a region of the holding member in contact with the optical component; and
melting the holding member through the irradiation to weld the holding member to the optical component,
wherein before the laser light is irradiated, surface roughness of a portion of the optical component to be welded is greater than surface roughness of the holding member in contact with the portion.

2. The manufacturing method of an optical pickup device according to claim 1,
wherein: the optical component is a lens; and
the holding member is the pickup case.

3. The manufacturing method of an optical pickup device according to claim 1, wherein the surface roughness of the optical component is greater than a wavelength of the laser light.

4. The manufacturing method of an optical pickup device according to claim 1,
wherein: a surface of the holding member is finished into a mirror surface; and
a surface of the optical component is not finished into a mirror surface.

5. The manufacturing method of an optical pickup device according to claim 1, wherein the surface roughness of the optical component is 3.0 μm or below.

6. The manufacturing method of an optical pickup device according to claim 5, wherein the surface roughness of the optical component is 1.0 to 2.0 μm.

7. The manufacturing method of an optical pickup device according to claim 1,
wherein: the optical component is of non-crystalline resin; and
the holding member is of crystalline resin.

8. The manufacturing method of an optical pickup device according to claim 7, wherein laser welding is performed with resin configuration that surface free energy of the holding member formed of the crystalline resin is smaller than surface free energy of the optical component formed of the non-crystalline resin.

9. The manufacturing method of an optical pickup device according to claim 1, wherein before the welding process, any of UV ozone treatment, plasma treatment, and corona treatment is performed on a portion of the optical component to be welded.

10. The manufacturing method of an optical pickup device according to claim 1, wherein before the welding, surface roughness of a central part of the portion of the optical component to be welded is smaller than surface roughness of a portion therearound.

11. The manufacturing method of an optical pickup device according to claim 1, wherein the optical component has, at an end part of the welded portion thereof in the laser scanning direction, a portion more recessed than other positions of the welded portion.

12. An optical pickup device comprising:
a pickup case;
an optical element; and
an optical component welded to a holding member,
wherein a welded portion between the optical component and the holding member has greater roughness at a surrounding portion thereof than a central portion thereof.

13. The optical pickup device according to claim 12,
wherein: the optical component is lens; and
the holding member is the pickup case.

14. The optical pickup device according to claim 12,
wherein: the optical component is of non-crystalline resin; and
the holding member is of crystalline resin.

15. The optical pickup device according to claim 12,
wherein: a welded surface of the holding member is finished into a mirror surface; and
a welded surface of the optical component is not finished into a mirror surface.

16. The optical pickup device according to claim 14, wherein surface free energy of the holding member formed of the crystalline resin is smaller than surface free energy of the optical component formed of the non-crystalline resin.

17. The optical pickup device according to claim 12, wherein any of UV ozone treatment, plasma treatment, and corona treatment is performed on the welded portion of the optical component.

18. The optical pickup device according to claim 12,
wherein: the optical component has at a longitudinal end part of the welded portion a portion more recessed than other portions thereof; and
the recessed portion is formed with a fillet of the holding member to be welded.

19. A manufacturing method of a welded structure with a first member welded to a second member, the manufacturing method comprising the steps of:
bringing the first member through which laser light can be transmitted into contact with the second member through which the laser light is not transmitted;
irradiating the laser light through the first member to a region of the second member in contact with the first member; and
melting the second member through the irradiation to weld the second member to the first member,
wherein before the laser light is irradiated, surface roughness of a portion of the first member to be welded is greater than surface roughness of the second member in contact with the portion.

20. A welded structure with a first member welded to a second member,
wherein: the laser light can be transmitted through the first member and is not transmitted through the second member; and
a welded portion between the first member and the second member has greater roughness at a surrounding portion thereof than at a central portion thereof.
